(19) United States
(12) Patent Application Publication
(10) Pub. No.: US 2011/0296491 A1
(43) Pub. Date: Dec. 1, 2011

(54) ACCOUNT SERVER AND NETWORK ACCESS METHOD USING THE SAME

(75) Inventors: Toshihiro Morohoshi, Kawasaki-shi (JP); Kiyoshi Hoshino, Ome-shi (JP); Shinichi Nakahara, Naka-gun (JP)

(73) Assignee: KABUSHIKI KAISHA TOSHIBA, Tokyo (JP)

(21) Appl. No.: 13/046,592

(22) Filed: Mar. 11, 2011

(30) Foreign Application Priority Data
May 31, 2010 (JP) 2010-125294

(51) Int. Cl. G06F 21/20

(52) U.S. Cl. 726/3

(57) ABSTRACT

According to one embodiment, an account server includes a first communication module, a second communication module, a database, and a controller. The first communication module receives a logon request from an electronic device, and establishes a session with the device. The second communication module obtains data from a service site connected to a network. The database associatively stores data for identifying electronic devices, data for identifying and accessing service sites, and names of services. The controller receives a service name from an electronic device which is established a session, obtains data from a service site by using data for identifying and accessing the site, and sends the data to the electronic device which is established a session.

### CROSS-REFERENCE TO RELATED APPLICATIONS

This application is based upon and claims the benefit of priority from Japanese Patent Application No. 2010-125294, filed May 31, 2010, the entire contents of which are incorporated herein by reference.

### FIELD

Embodiments described herein relate generally to improvement of an account server configured to access various service sites connected to a network based on requests from household electronic devices held by a user, and a method of accessing a network by means of the account server.

### BACKGROUND

Various kinds of consumer electronic (CE) devices are available on the market as household electronic devices in recent years. Typical CE devices include a television broadcast receiver for receiving terrestrial broadcast, satellite broadcast and cable broadcast, a recording/reproduction device for recording and reproducing audio/video content stored on an optical disc and in a semiconductor memory, and a personal computer (PC).

At present, there is an application server configured to provide CE devices with a list of recommendable programs, programming ranking, and other services. In addition, there are Web services to provide an address book, schedule table management, and searching, for example. It is possible to use such services from a personal computer through a web browser.

The above application server is usually a closed system, which identifies each CE device by data peculiar to each device, and provides information to an identified device. On the other hand, in Web service, a provider manages its own account, and requires a user to input account data (a logon ID, and a password) created for each service when using service. Therefore, it is strongly demanded to simplify input operation when the user requests Web service from a CE device.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is a block diagram for explaining an example of an account server according to a first embodiment;

FIG. 2 is a flowchart for explaining an example of operation to register account data and external service ID data in the account server of the first embodiment;

FIG. 3 is a flowchart for explaining an example of operation to register device data in the account server of the first embodiment;

FIG. 4 is a flowchart for explaining an example of primary operation of the account server of the first embodiment;

FIG. 5 is a block diagram for explaining an example of an account server according to a second embodiment;

FIG. 6 is a flowchart for explaining an example of main operations of the account server of the second embodiment;

FIG. 7 is a block diagram for explaining an example of an account server according to a third embodiment;

FIG. 8 is a flowchart for explaining an example of main operations of the account server of the third embodiment;

FIG. 9 is a block diagram for explaining an example of an account server according to a fourth embodiment;

FIG. 10 is a flowchart for explaining an example of operations for registering programmed recording data in the account server of the fourth embodiment; and

FIG. 11 is a flowchart for explaining an example of main operations of the account server of the fourth embodiment.

### DETAILED DESCRIPTION

Various embodiments will be described hereinafter with reference to the accompanying drawings. In general, according to one embodiment, an account server comprises a first communication module, a second communication module, a database, and a controller. The first communication module receives a logon request from an electronic device, and establishes a session with the device. The second communication module obtains data from a service site connected to a network. The database associatively stores data for identifying electronic devices, data for identifying and accessing service sites, and names of services. The controller receives a service name from an electronic device which is established a session, obtains data from a service site by using data for identifying and accessing the site, and sends the data to the electronic device which is established a session.

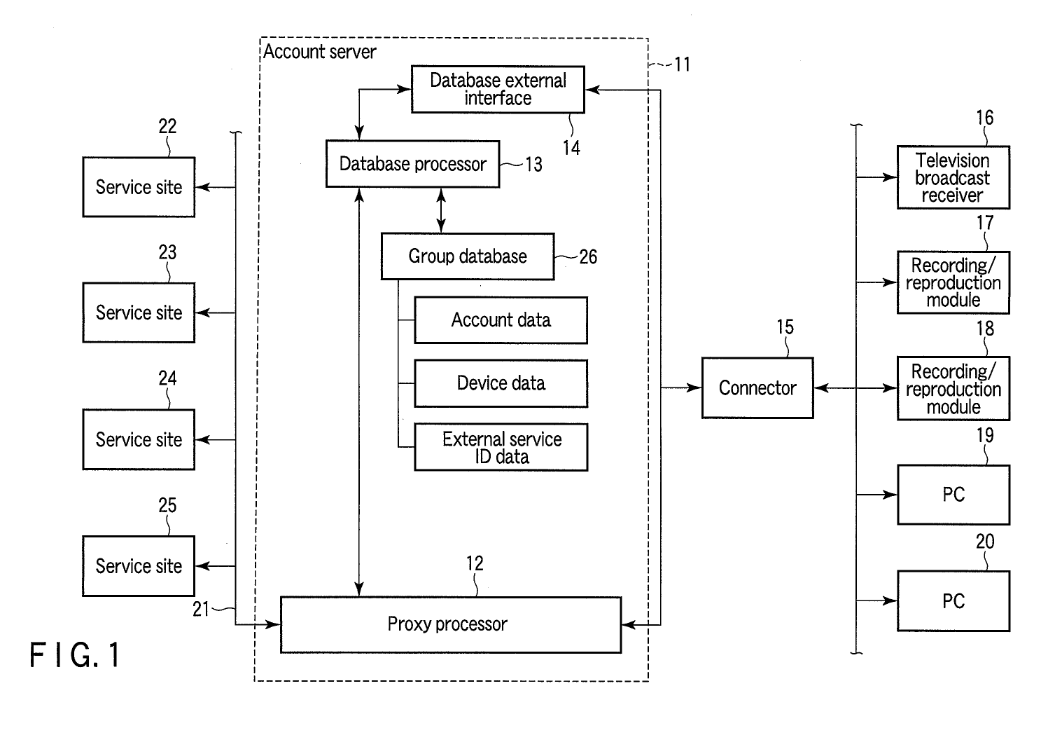

FIG. 1 shows an example of an account server 11 according to a first embodiment. The account server 11 comprises a proxy processor 12, a database processor 13, and a database external interface 14. The proxy processor 12 is selectively communicable with a plurality of CE devices 16 to 20 (five in the drawing) through a connector 15.

In this case, the CE devices 16 to 20 are assumed to be a television broadcast receiver 16 for receiving terrestrial broadcast, satellite broadcast and cable broadcast, two recording/reproduction devices 17 and 18 for recording and reproducing audio/video content stored on an optical disc and in a semiconductor memory, and two personal computers 19 and 20.

The CE devices 16 to 20 belong to one group in the same family, for example, and the same home ID (a unified ID) is previously set in the same group. Each device 16 to 20 permits setting of a member ID assuming that each member of the group uses the device by its own setting.

The proxy processor 12 is connected to a network 21, such as the Internet, and selectively accessible to a plurality of service sites 22, 23, 24 and 25 (four in the drawing) connected to the network 21. In this configuration, when one CE device (e.g. the device 16) receives a request to receive service data provided by a service site (e.g. the device 22), the proxy processor 12 accesses the service site 22, retrieves the service data, and supplies the data to the CE device.

The proxy processor 12 is connected to the database processor 13. The database processor 13 creates a group database 26, which is a database of each group. The group database 26 stores account data, device data, and external service ID data.

The account data includes a home ID and a password of each EC device 16 to 20 belonging to the same group. When a member ID is already set, the member ID is added to a home ID.

The device data is the data peculiar to each CE device 16 to 30 belonging to the same group, which includes a serial number (SN) and a product ID, for example.

The external service ID data includes a logon ID, a password, and an access method (uniform resource locator (URL)) for each service site 22 to 25 connected to the network 21, to which a service name provided by each service site 22 to 25 is associatively added.

A service name provided by each service site 22 to 25 is previously set for each CE device 16 to 20 described above. Each CE device displays a list of preset service names, selects a desired service name, and requests the service of that service name.

A service name may be a portal screen name in each service site 22 to 25, or an image itself of a portal screen. In addition to presetting in each CE device, a service name may be downloaded from each service site 22 to 25, and set in each CE device 16 to 20.

The database external interface 14 is connected to the database processor 13. The interface 14 is used to access the account server 11 through the network 21, register an external service ID data, and maintain the account server 11, by means of a Web browser of a personal computer.

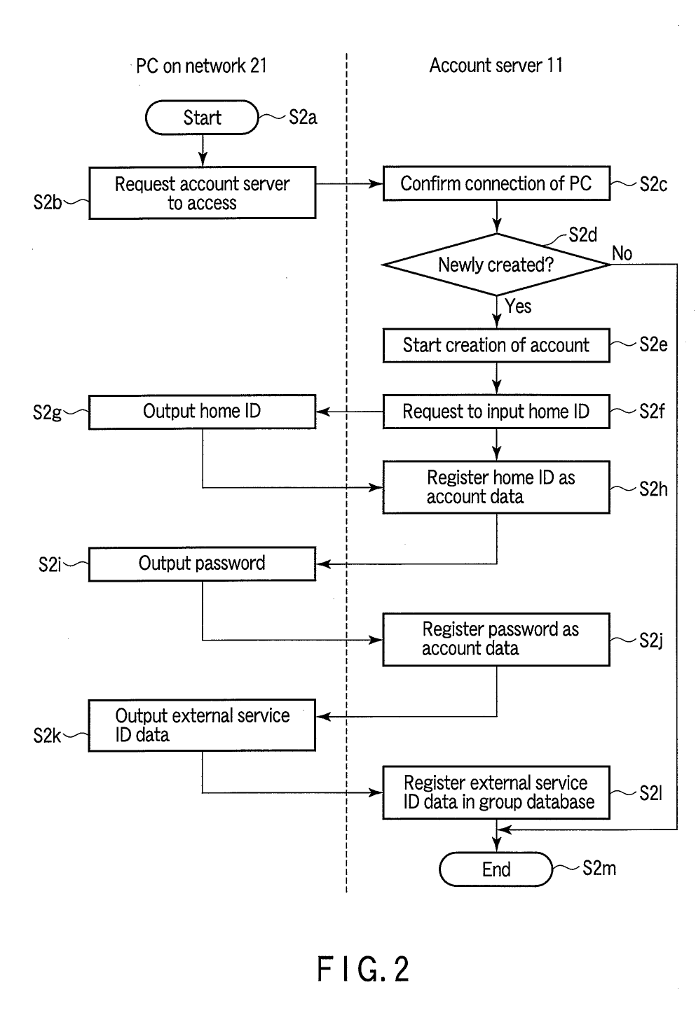

FIG. 2 shows a flowchart of a procedure of creating account data and external service ID data to be stored in the group database 26. The procedure is executed by a personal computer (not shown) connected to the network 21 by controlling the account server 11.

When the procedure is started (step S2a), the personal computer connected to the network 21 requests the account server 11 to access in step S2b. The account server confirms the connection of the personal computer in step S2c, determines whether it is a request to create a new account, in step S2d, and terminates the procedure (step S2m) when it is not a request to create a new account (NO).

When it is determined to be a request to create a new account in step S2d (YES), the account server 11 starts creation of a new account in step S2e, and requests the personal computer on the network 21 to input a home ID in step S2f. The personal computer sends the account server 11 the same home ID as that assigned to each CE device 16 to 20, in step S2g. In this case, if a member ID is already assigned, the member ID is also sent to the account server 11.

The account server 11 registers the home ID and member ID supplied from the personal computer on the network 21, in the database 26 as account data, in step S2h.

Thereafter, the personal computer on the network 21 outputs a password of each CE device 16 to 20 to the account server 11, in step S2i. The account server 11 registers a password supplied from the personal computer on the network 21, in the group database 26 as account data, in step S2j.

Then, the personal computer on the network 21 outputs external service ID data about each service site 22 to 25 to the account server 11, in step S2k. The account server 11 registers the external service ID data supplied from the personal computer on the network 21, in the group database 26, in step S2l, and terminates the procedure (step S2m).

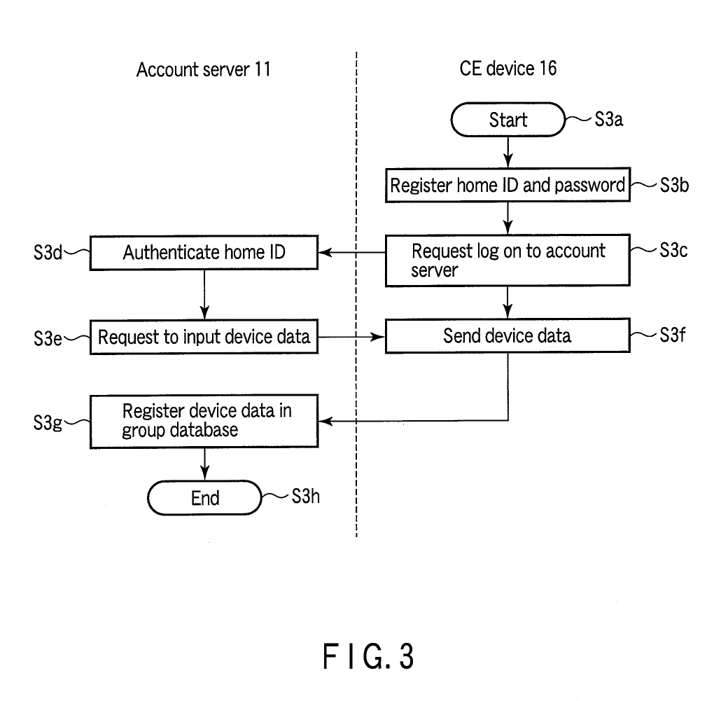

FIG. 3 shows a flowchart of a procedure of creating device data to be stored in the group database 26. The procedure is executed by the CE device 16, a member of the same group, by accessing the account server 11, and sending its device data. As for the other CE devices 17 to 20, the operations are the same as that of the CE device 16, and an explanation thereof is omitted.

When the procedure is started (step S3a), the CE device 16 registers a home ID and a password in step S3b, and sends the registered home ID and password to the account server 11, and requests to log onto the account server, in step S3c. The account server 11 authenticates the home ID in step S3d, and when it is authenticated, requests the CE device 16 to input device data, in step S3e.

The CE device 16 sends its device data to the account server 11 in step S3f. The account server 11 registers the device data supplied from the CE device 16 in the group database 26, in step S3g, and terminates the procedure (step S3h).

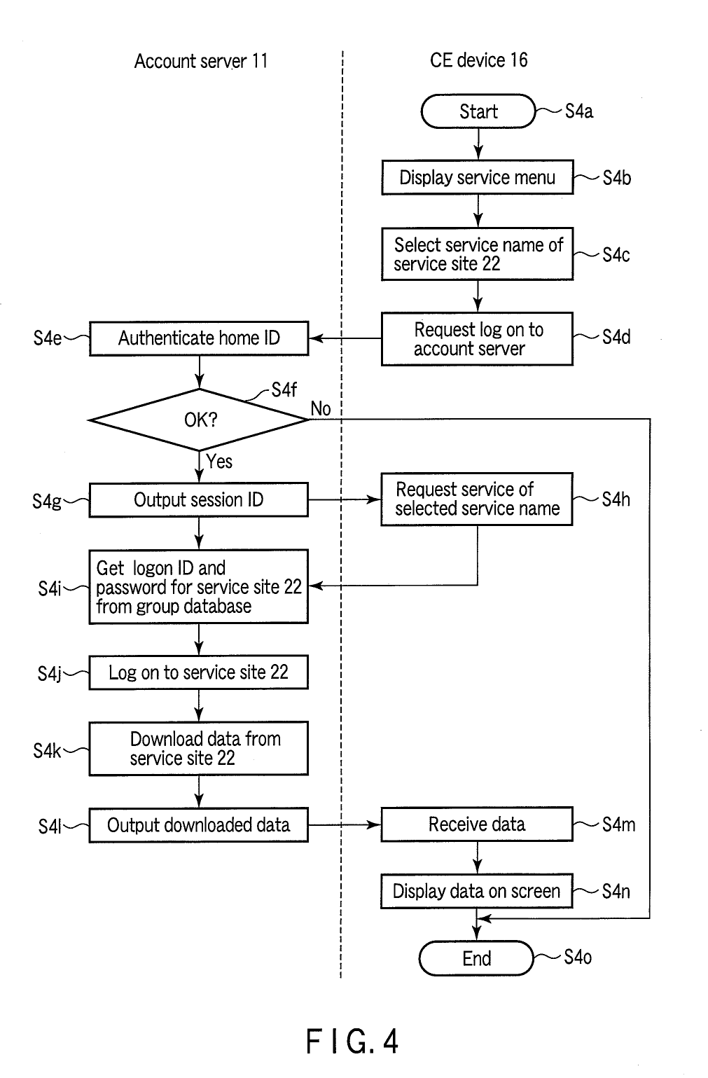

FIG. 4 shows a flowchart of a procedure of obtaining service data provided by the service site 22 by the CE device 16 by means of the account server 11 including the group database 26. The operations of other CE devices 17 to 20 for obtaining the service data provided by the service sites 22 to 25 are the same, and an explanation thereof is omitted.

When the procedure is started (step S4a), the CE device 16 displays a menu showing a list of service names provided by the service sites 22 to 25, in step S4b. When one of the service names provided by the service site 22 is selected in step S4c, the CE device 16 sends its own home ID and password to the account server 11, and requests to log on, in step S4d.

The account server 11 authenticates the home ID supplied sent from the CE device 16 in step S4e, and determines whether the home ID is authenticated in step S4f, and when it is not authenticated (NO), terminates the procedure (step S4o).

When the home ID is authenticated in step S4f (YES), the account server 11 sends a session ID to the CE device 16, and establishes a session with the CE device 16, in step S4g. The CE device 16 sends the service name and session ID of the previously selected service site 22 to the account server 11, and request service, in step S4h.

The proxy processor 12 of the account server 11 gets a logon ID and password for the service site 22 from the group database 26 in step S4i, and the account server 11 logs onto the service site 22 in step S4j. The account server 11 downloads necessary data from the service site 22 in step S4k, and sends the data to the CE device 16, to which the session ID has been sent, in step S4l.

The CE device 16 receives the data supplied from the account server 11 in step S4m, and displays the data in step S4n, and terminates the procedure (step S4o).

According to the above first embodiment, the same home ID is set for the CE devices 16 to 20 constituting the same group, and the account server 11 stores the data for logging onto the service sites 22 to 25 on the network 21 as the group database 26.

A session is established by one of CE devices (for example, the device 16) by logging onto the account server by using a home ID. In this state, the CE device 16 selects a desired service from the service list. The account server 11 refers to the group database 26, logs onto the service site 22 which supplies the requested service, and downloads and supplies data to the CE device 16. Therefore, the CE device 16 can receive services through the network 21 by simple operations.

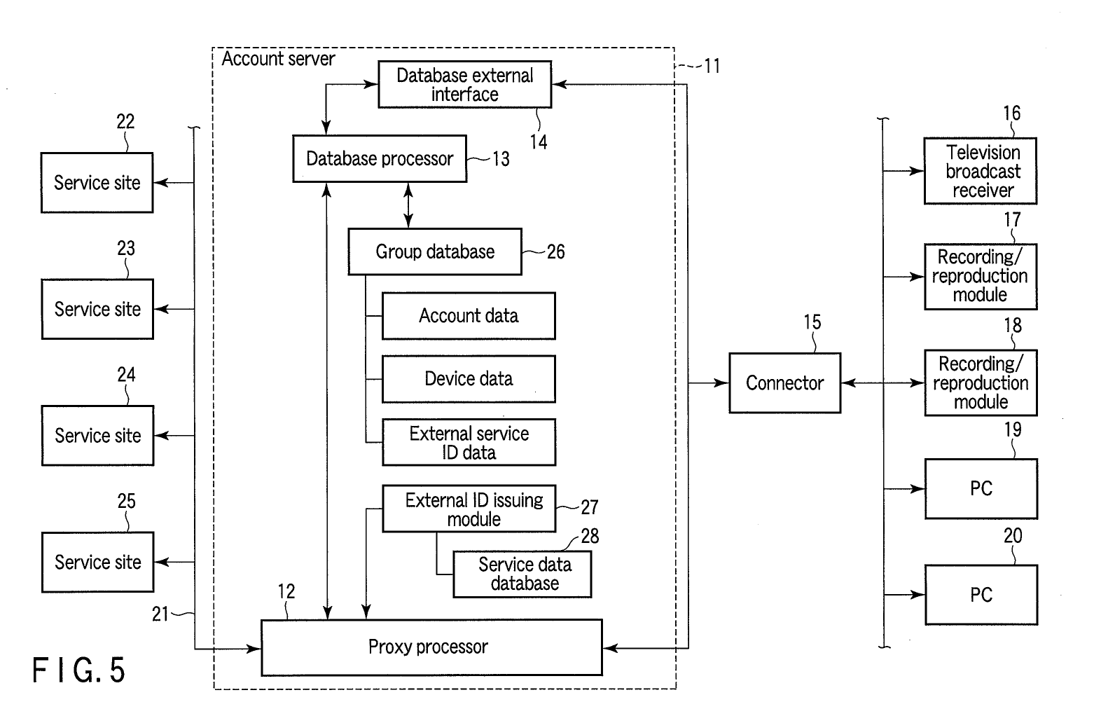

FIG. 5 shows a second embodiment. In FIG. 5, the same parts as those in FIG. 1 are given the same numbers. The proxy processor 12 is connected to an external ID issuing module. The external ID issuing module 27 automatically issues a tentative logon ID and password, when a logon request is made for a service site (for example, the site 22) whose external service ID data is not recorded in the group database 26.

In this case, the external ID issuing module 27 automatically issues a tentative logon ID and password based on the logon ID issuance rule for the service sites 22 to 25 on the network 21 recorded in a service data database 28. The proxy processor 12 executes logging onto the service site 22 based on the tentative logon ID and password issued by the external ID issuing module 27.

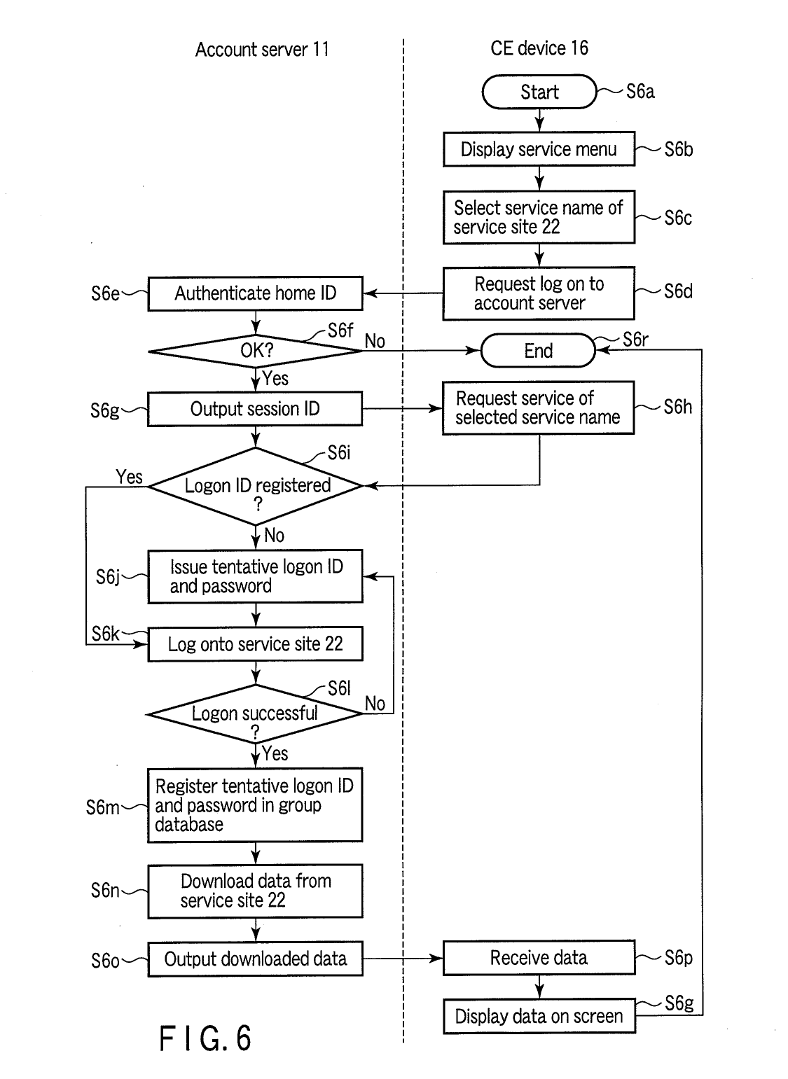

FIG. 6 shows a flowchart of operations to be executed when an ID to log onto the service site 22 providing service data requested by the CE device 16 is not recorded in the group database 26. The same operations are executed when IDs to log onto the service sites 22 to 25 providing the service data requested by the other CE devices 17 to 20 are not recorded in the group database 26, and an explanation thereof is omitted.

When the procedure is started (step S6a), the CE device 16 displays a menu showing a list of service names provided by the service sites 22 to 25 in step S6b. When one of the service names provided by the service site 22 is selected in step S6c, the CE device 16 sends its own home ID and password to the account server 11, and requests logon in step S6d.

The account server 11 authenticates the home ID sent from the CE device 16 in step S6e, and determines whether the home ID is authenticated in step S6f, and when it is not authenticated (NO), terminates the procedure (step S6r).

When the home ID is authenticated in step S6f (YES), the account server 11 sends a session ID to the CE device 16, and establishes a session with the CE device 16, in step S6g. The CE device 16 sends the service name and session ID of the previously selected service site 22 to the account server 11, and requests service, in step S6h.

In step S6i, the account server 11 determines whether the ID to log onto the service site 22 providing the service requested by the CE device 16 is registered in the group database 26.

When the logon ID is not registered (NO), the account server 11 causes the external ID issuing module 27 to issue a tentative logon ID and password in step S6j. The proxy processor 12 logs onto the service site 22 in step S6k. When the logon ID is registered (YES) in step S6i, the account server 11 directly moves to the next step S6k.

Then, the account server 11 determines whether logging onto the service site 22 was successful in step S6l. If logon was not successful (NO), the account server 11 goes back to step S6j, and a tentative logon ID and password are issued. If logon was successful (YES) in step S6l, the account server 11 registers the tentative logon ID and password used for the logon in the group database 26 in step S6m.

Then, the account server 11 downloads necessary data from the service site 22 logged onto in step S6n, and sends the data to the CE device 16 to which the session ID was sent, in step S6o. The CE device 16 receives the data from the account server 11 in step S6p, and displays the data on the screen in step S6q, and terminates the procedure (step S6r).

According to the above second embodiment, the same effects as those of the first embodiment are obtained, and when there occurs a request to log onto the service site 22 whose logon ID is not recorded in the group database 26, a tentative logon ID and password are automatically issued, and steps to be followed by the user are simplified.

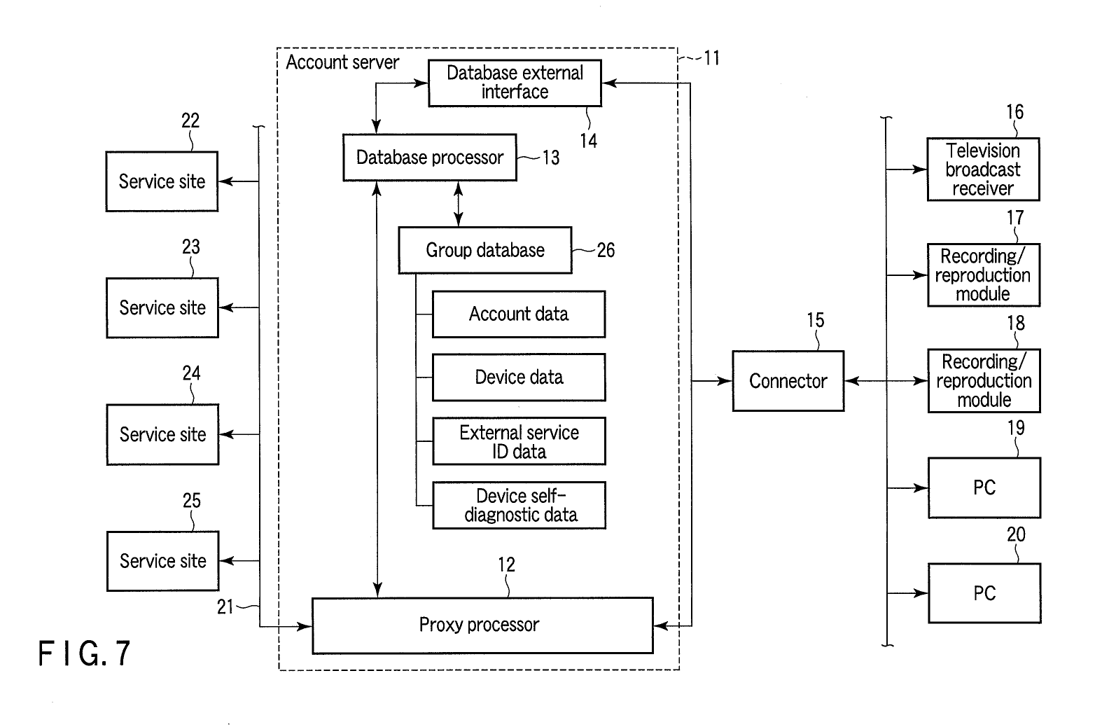

FIG. 7 shows a third embodiment. In FIG. 7, the same parts as those in FIG. 1 are given the same numbers. The group database 26 includes device self-diagnostic data. The device self-diagnostic data includes the results of periodical or occasional diagnosis of the CE devices 16 to 20 registered in association with the product IDs of these devices.

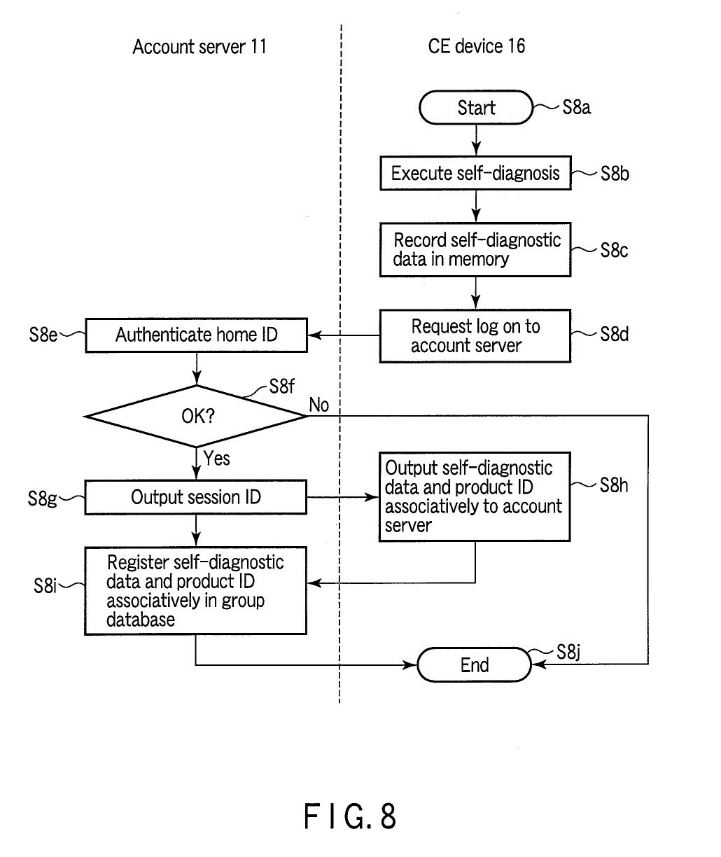

FIG. 8 shows a flowchart of operations of the CE device 16 for registering the results of self-diagnosis in the group database 26 of the account server 11. The operations of other CE devices 17 to 20 for registering the results of self-diagnosis in the group database 26 of the account server 11 are the same, and an explanation thereof is omitted.

When the procedure is started (step S8a), the CE device 16 executes self-diagnosis in step S8b, and records the result of self-diagnosis in its nonvolatile memory (not shown) in step S8c. Then, the CE device 16 sends its home ID and password to the account server 11 in step S8d, and makes a logon request.

The account server authenticates the home ID sent from the CE device 16 in step S8e, and determines whether the home ID is authenticated in step S8f. When the home ID is not authenticated (NO), the account server 11 terminates the procedure (step S8j).

When the home ID is authenticated (YES) in step S8f, the account server 11 sends a session ID to the CE device 16 in step S8g, and establishes a session with the CE device 16. The CE device 16 outputs its diagnostic data associated with its product ID to the account server 11 in step S8h.

In step S8i, the account server 11 registers the self-diagnostic data of the CE device 16 in association with the product ID in the group database 26, and terminates the procedure (step S8j).

According to the above third embodiment, the same effects as those of the first embodiment are obtained, and as the self-diagnostic data of the CE devices 16 to 20 in the same group is registered in the account server 11, the user can know the states of the CE devices 16 to 20, and steps to be followed by the user are simplified.

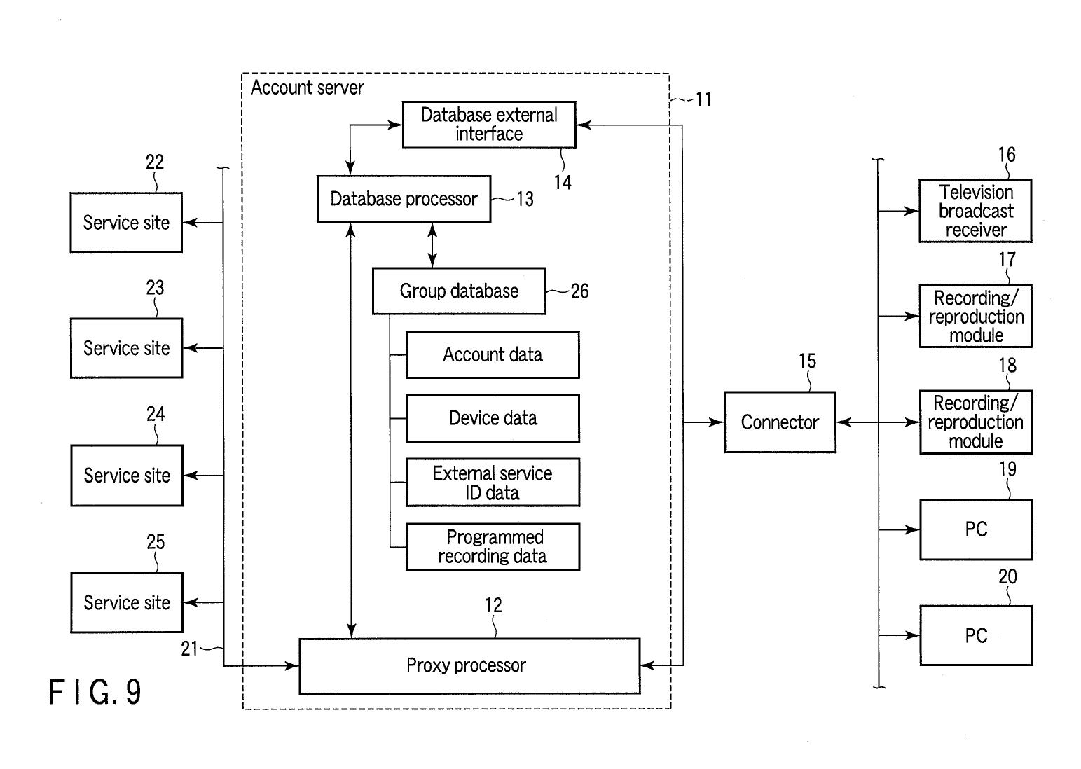

FIG. 9 shows a fourth embodiment. In FIG. 9, the same parts as those in FIG. 1 are given the same numbers. The group database 26 includes programmed recording data. The programmed recording data includes programmed recording data set for the CE devices 16 to 20 registered in association with the product IDs of these devices.

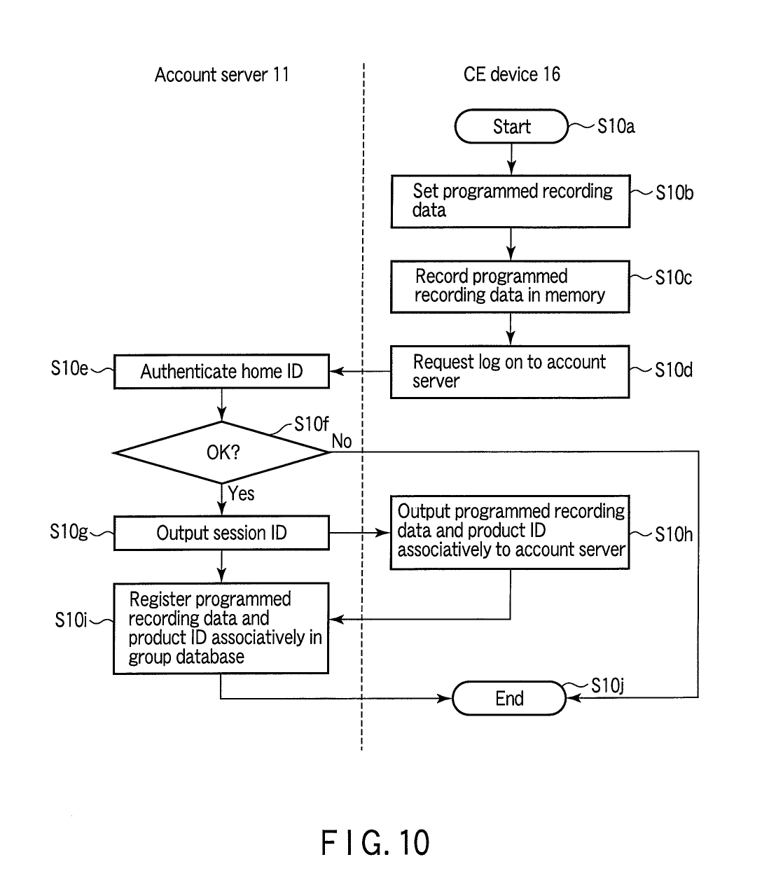

FIG. 10 shows a flowchart of operations of the CE device 16 for registering programmed recording data set for itself in the group database 26 of the account server 11. The operations of other CE devices 17 to 20 for registering programmed recording data set for itself in the group database 26 of the account server 11 are the same, and an explanation thereof is omitted.

When the procedure is started (step S10a), and programmed recording data is set in step S10b, the CE device 16 records the programmed recording data in its nonvolatile memory (not shown) in step S10c. Then, the CE device 16 sends its home ID and password to the account server 11, and makes a logon request in step S10d.

The account server authenticates the home ID sent from the CE device 16 in step S10e, and determines whether the home ID is authenticated in step S10f. When the home ID is not authenticated (NO), the account server 11 terminates the procedure (step S10j).

When the home ID is authenticated (YES) in step S10f, the account server 11 sends a session ID to the CE device 16 in step S10g, and establishes a session with the CE device 16. The CE device 16 outputs the programmed recording data in association with its product ID to the account server 11 in step S10h.

In step S10i, the account server 11 registers the programmed recording data of the CE device 16 in association with the product ID in the group database 26, and terminates the procedure (step S10j).

According to the above fourth embodiment, the same effects as those of the first embodiment are obtained, and as the programmed recording data of the CE devices 16 to 20 in the same group is registered in the account server 11, the user can know the states of programmed recording set in the CE devices 16 to 20, and steps to be followed by the user are simplified.

Further, since the programmed recording data set in the CE devices 16 to 20 in the same group are registered in the account server 11, for example, the CE device 18, a recording-reproduction device, can read out the programmed recording data set in another CE device 17, a recording-reproduction device, and set it for itself.

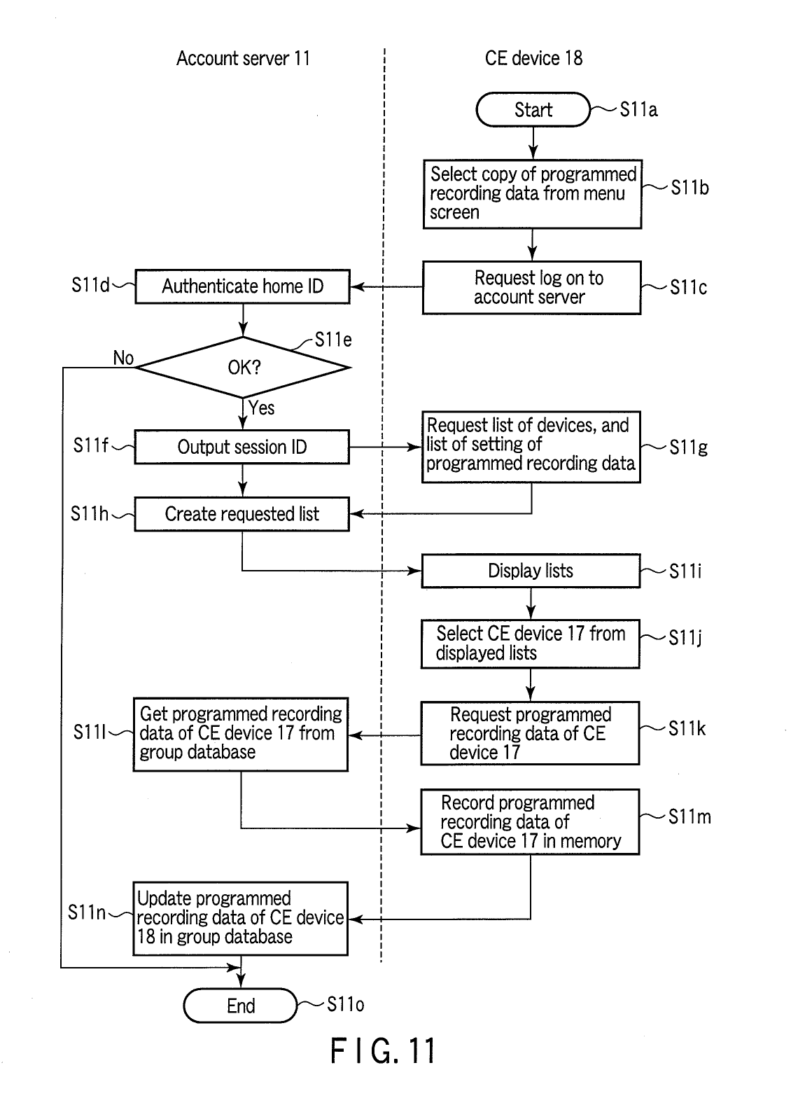

FIG. 11 shows a flowchart of operations of the CE device 18 for reading programmed recording data set for the CE device 17 out of the programmed recording data registered in the account server 11, and setting the data for itself. When the procedure is started (step S11a), the CE device 18 displays a menu screen in step S11b, selects a copy of the programmed recording data from the menu, and sends its home ID and password to the account server 11, and makes a logon request in step S11c.

The account server 11 authenticates the home ID sent from the CE device 18 in step S11d, and determines whether the home ID is authenticated in step S11e. When the home ID is not authenticated (NO), the account server 11 terminates the procedure (step S11o).

When the home ID is authenticated (YES) in step S11e, the account server 11 sends a session ID to the CE device 18 in step S11f, and establishes a session with the CE device 18. In step S11g, the CE device 18 requests the account server 11 to send a list of all CE devices in a group, and a list indicating whether programmed recording data is set for each CE device.

In step S11h, the account server 11 creates the requested lists based on the data registered in the group database 26, and sends the lists to the CE device 18. The CE device 18 displays the lists sent from the account server 11 on the screen in step S11i, and select the CE device 17 from the displayed lists in step S11j, and requests the account server 11 to get the programmed recording data of the CE device 17 in step S11k.

The account server 11 gets the programmed recording data set for the CE device 17 from the group database 26, and sends the data to the CE device 18 in step S11l. The CE device records the programmed recording data of the CE device 17 sent from the account server 11 in its nonvolatile memory in step Slim. Thereafter, the account server 11 updates the programmed recording data of the CE device 18 in the group database 26 in step S11n, and terminates the procedure (step S11o).

Namely, the programmed recording data of a CE device (for example, the device 17) can be easily copied to another CE device 18, for example, in the same group, and the data can be easily shared by the devices in the same group.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An account server comprising:
a first communication module configured to:
selective and communicably connect to a plurality of electronic devices given the same device-identification data,
receive a logon request accompanied by device-identification data from a designated electronic device, and
establish a session with the electronic device when the device-identification data is authenticated;
a second communication module configured to:
selectively and communicably connect to a plurality of service sites connected to a network,
logs onto a designated service site by using access-identification data set for each service site, and
get data from the service site;
a database configured to register device-identification data given to the electronic devices, access-identification data set for each service site, and service names provided by the service sites in association with each other;
a controller configured to:
receive a request to get service by a service name from an electronic device having a session established by the first communication module,
get access-identification data for accessing a service site providing the service of the service name from the database,
receive data by logging onto the service site by the second communication module, and
send the received data to the electronic device having the session established by the first communication module; and
an issuing module configured to:
receive a request to get service by a service name from an electronic device having a session established b the first communication module, and
automatically issue tentative access-identification data, when access-identification data for accessing a service site providing the service of the service name is not registered in the database.

2. (canceled)

3. The account server of claim 1, wherein the issuing module is configured to automatically issue other tentative access-identification data, when an object service site is not logged onto by using issued tentative access-identification data.

4. The account server of claim 1, wherein the issuing module is configured to automatically issue tentative access-identification data, based on rules of issuing access-identification data for accessing service sites connected to the network.

5. The account server of claim 1, wherein the database is configured to register self-diagnostic data of the electronic devices in association with the data to identify the electronic devices.

6. The account server of claim 1, wherein the database is configured to register programmed recording data set for the electronic devices in association with the data to identify the electronic devices.

7. The account server of claim 6, wherein programmed recording data of a designated electronic device registered in the database is recorded by selecting another electronic device.

8. (canceled)
